(19) United States
(12) Patent Application Publication
(10) Pub. No.: US 2006/0061868 A1
(43) Pub. Date: Mar. 23, 2006

(54) Antireflection structure and optical material comprising the same

(75) Inventors: Hideshi Hattori, Tokyo-To (JP); Shouichi Kiso, Tokyo-To (JP); Takanori Sekizuka, Tokyo-To (JP); Toshiyuki Hasegawa, Tokyo-To (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 11/188,131

(22) Filed: Jul. 22, 2005

(30) Foreign Application Priority Data
Jul. 28, 2004 (JP) 2004-220395
Jul. 28, 2004 (JP) 2004-220426
Jul. 11, 2005 (JP) 2005-201866
Jul. 11, 2005 (JP) 2005-201879

(51) Int. Cl. G02B 5/08

(52) U.S. Cl. 359/603

(57) ABSTRACT

An antireflection structure having on its surface an antireflection face having fine concaves or convexes, wherein 10 to 90% of the effective area of the antireflection face is accounted for by the concaves or convexes. The concaves or convexes include basic forms which may be connected to each other. The basic forms have an average length of 30 nm to 200 nm and an average diameter of 80 nm to 400 nm, and the basic forms are substantially irregularly arranged on the antireflection face. The antireflection structure can be used as an optical member to effectively prevent light reflection. For example, in the case of an optical member for information display such as display devices, the visibility can be improved, and, in the case of a light receiving optical member such as solar battery panels, the efficiency for light utilization can be improved.

### TECHNICAL FIELD

The present invention relates to an optical material or member, particularly an antireflection structure for preventing or reducing surface reflection of light permeable members, an optical member having this antireflection structure, a display device, and a solar battery panel. Further, the present invention relates to a master, which can mass produce this antireflection structure in an easy and low-cost manner, and a process for producing the same.

### BACKGROUND ART

In optical members, particularly light permeable members, prevention or suppression of light reflection of the surface has hitherto been carried out. For example, visibility of information display and efficiency of light utilization have been improved by rendering, antireflective, the surface of information display parts of various types of information equipment, for example, display parts such as televisions, computers, portable telephones (cellular phones), and information terminals, solar batteries, windowpanes, mirrors, light receiving parts such as various optical elements, members for polarization, refraction or lighting control, for example, lenses or filters.

Such antireflection can be carried out by forming fine concaves and convexes on the surface. To this end, a coating method using a coating liquid containing an antireflection material (for example, Japanese Patent Laid-Open No. 133002/1998), a vapor deposition method (for example, Japanese Patent Laid-Open No. 66203/2003), or a diffraction grating preparation method (for example, Japanese Patent Laid-Open No. 344630/2003) have hitherto been adopted.

### DISCLOSURE OF THE INVENTION

In optical members, the fine convex-concave shape on the surface thereof greatly affects optical characteristics of the optical members. Therefore, the concave-convex shape should be determined by comprehensively judging necessary antireflection properties, other optical properties and the like. In order to realize necessary antireflection properties, however, it is not easy to form predetermined convexes and concaves on the surface of the optical material and to mass produce optical members having predetermined convexes and concaves in a stable and low-cost manner.

For example, the above coating method disadvantageously cannot be applied to optical members with a surface having a complicated geometrical shape without difficulties. The vapor deposition method is disadvantageous, for example, in that an expensive reactor should be used. Further, the diffraction grating preparation method disadvantageously requires a precision optical system for diffraction grating preparation. In particular, in the case of the vapor deposition method or diffraction grating preparation method, an apparatus consistent with the size, the shape and the like of the optical member to be treated should be used. In recent years, an increase in size of the optical member has led to a tendency that the provision of an apparatus suitable for the large optical member cannot be said to be advantageous for economic reasons.

Accordingly, it has been difficult to mass produce an antireflection structure having fine concaves and convexes and an optical member comprising the antireflection structure in a stable, easy and cost-effective manner.

In view of the above problems of the prior art, the present invention has been made, and the present invention relates to an antireflection structure with predetermined fine concaves (hereinafter often referred to as “first antireflection structure”), an optical member comprising the antireflection structure, a master for the formation of the antireflection structure, a process for producing the same, and a process for producing a replication mold.

The term “replication mold” as used herein refers to a mold which can replicate an antireflection structure comprising predetermined concaves according to the present invention and an optical member having this antireflection structure and has a surface shape which is in a reversed shape relationship with the antireflection structure (the so-called “negative mold”). That is, this “replication mold” is the so-called a stamper for producing an antireflection structure comprising fine concaves according to the present invention and has convexes on its surface.

This “replication mold” (having predetermined convexes on its surface) can be produced by first preparing “a master for forming an antireflection structure” (having predetermined concaves on its surface) and transferring the surface shape of the master once or repeating the transfer of the surface shape of the master a plurality of times.

Further, the present invention relates to an antireflection structure with predetermined fine convexes (hereinafter often referred to as “second antireflection structure”), an optical member comprising the antireflection structure, a master for the formation of the antireflection structure, a process for producing the same, and a process for producing a replication mold.

The term “replication mold” as used herein refers to a mold which can replicate an antireflection structure comprising predetermined convexes according to the present invention and an optical member having this antireflection structure and has a surface shape which is in a reversed shape relationship with the antireflection structure (the so-called “negative mold”). That is, this “replication mold” is the so-called a stamper for producing an antireflection structure comprising fine convexes according to the present invention and has concaves on its surface.

This “replication mold” (having predetermined concaves on its surface) can be produced by first preparing “a master for forming an antireflection structure” (having predetermined convexes on its surface) and transferring the surface shape of the master once or repeating the transfer of the surface shape of the master a plurality of times.

(1) First Antireflection Structure and Optical Member Having this Antireflection Structure

The first antireflection structure according to the present invention is an antireflection structure having on its surface an antireflection face having fine concaves, wherein 10 to 90% of the effective area of the antireflection face is accounted for by said concaves, and said concaves comprise basic forms which may be connected to each other, said basic forms have an average depth of 30 nm to 200 nm and an average diameter of 80 nm to 400 nm, and said basic forms are substantially irregularly arranged on said antireflection face.

The fine concaves refer to concaves formed of basic forms defined below and formed on a surface, as a reference surface, of a base material which can be regarded as substantially flat over a region of micrometer as a unit, for example, a region of 100 μm².

The basic forms refer to elements of concaves defined by the average depth and the average diameter. The average depth is a depth determined by measuring the depth of basic forms constituting fine concaves defined above each at least once for basic forms of three or more concaves and arithmetically averaging the measured values. The average diameter is a diameter determined by measuring the diameter of basic forms constituting fine concaves defined above each at least once for basic forms of three or more concaves and arithmetically averaging the measured values.

Regarding elements comprising basic forms constituting the concaves, there are two cases, that is, a case where the elements each substantially independently form concaves and a case where the elements are mutually substantially connected, for example, like a strip, or as a mass to form concaves. Whether the elements comprising basic forms are present independently of each other or are mutually connected is judged based on the shape relationship between elements determined from a surface image and a sectional image taken with a scanning electron microscope.

The expression “substantially irregularly” as used herein means that the basic forms of concaves are neither formed on the surface of the base material in a calculated artificial distribution, nor distributed in a size suitable for developing macroscopic optical properties in a diffraction grating form or a photonic crystal form artificially or by self-organization, but are distributed substantially randomly on the surface of the base material. In substantially irregular arrangements of basic forms of concaves according to the present invention, in some cases, several to several tens of basic forms of concaves are incidentally distributed on a micrometer scale partially and with low frequency in a diffraction grating-like or photonic crystal-like form. This is an accidental product of which the size is much smaller than a size which exhibits macroscopic light diffraction effect- or photonic crystal structure-derived optical effect.

In the antireflection structure according to the present invention, preferably, the frequency distribution of the diameter of the basic form of said concaves is narrow.

In the antireflection structure according to the present invention, preferably, the frequency distribution of the diameter of the basic form of said concaves is narrow and such that the number of concaves which are different in diameter by not more than 75 nm from concaves of the highest frequency is not less than 70% of the number of concaves which are different in diameter by not more than 300 nm from concaves of the highest frequency.

In the antireflection structure according to the present invention, preferably, the proportion of the basic form of said concaves not connected to each other to the total number of the basic form of said concaves is not less than 10%.

According to the present invention, there is provided an optical member comprising the above antireflection structure.

In a preferred embodiment of the optical member according to the present invention, the above antireflection structure is provided on a surface of a geometrical optical functional shape.

Further, according to the present invention, there is provided a display device comprising the above antireflection structure.

In a preferred embodiment of the display device according to the present invention, the above antireflection structure is provided on a surface of a geometrical optical functional shape.

According to the present invention, there is provided a solar battery panel comprising the above antireflection structure.

In a preferred embodiment of the solar battery panel according to the present invention, the above antireflection structure is provided on a surface of a geometrical optical functional shape.

According to the present invention, there is provided a master for the formation of an antireflection structure having on its surface an antireflection face having fine concaves, wherein said master comprises: a base material; and fine concaves provided on said base material, and wherein 10 to 90% of the effective area of the antireflection face is accounted for by said concaves, and said concaves comprise basic forms which may be connected to each other, said basic forms have an average depth of 30 nm to 200 nm and an average diameter of 80 nm to 400 nm, and said basic forms are substantially irregularly arranged on said antireflection face.

According to the present invention, there is provided a process for producing a master for the formation of an antireflection structure, said process comprising the steps of: in producing the above master, forming a substrate layer on the surface of a base material optionally by an alternate adsorption method; and then fixing fine particles on said substrate layer to form fine convexes.

In the process for producing a master for the formation of an antireflection structure according to the present invention, preferably, the formation of said substrate layer by the alternate adsorption method is carried out by using a combination of the step of immersing said base material in an aqueous positive electrolyte polymer solution with the step of immersing said base material in an aqueous negative electrolyte polymer solution.

Preferably, the process for producing a master for the formation of an antireflection structure according to the present invention comprises the step of depositing fine particles by applying a fine particle dispersion liquid onto said substrate layer.

In the process for producing a master for the formation of an antireflection structure according to the present invention, preferably, after the deposition of the fine particles, the fine particle-deposited surface is subjected to heat treatment and/or overcoating.

In the process for producing a master for the formation of an antireflection structure according to the present invention, preferably, the skirt part in the basic forms of convexes formed of the fine particles is not substantially in a reverse taper form.

Here the basic forms of convexes in a form which is not in a reverse taper form refers to convexes in a form similar to the form of a bowl, a mountain or the like, for example, convexes not in such a form that, when a spherical particle is placed on a certain plane, has a reversed taper skirt part defined by the spherical particle and the plane.

According to the present invention, there is provided a process for producing a replication mold from the master, said process comprising: providing the above master; and preparing a metallic negative mold for replicating the above antireflection structure from said master by a metal plating method.

(2) Second Antireflection Structure and Optical Member Comprising this Antireflection Structure

The second antireflection structure according to the present invention is an antireflection structure having on its surface an antireflection face with fine convexes, wherein 10 to 90% of the effective area of the antireflection face is accounted for by said convexes, and said convexes comprise basic forms which may be connected to each other, said basic forms have an average height of 30 nm to 200 nm and an average diameter of 80 nm to 400 nm, and said basic forms are substantially irregularly arranged on said antireflection face.

The fine convexes refer to convexes formed of basic forms defined below and formed on a surface, as a reference surface, of a base material which can be regarded as substantially flat over a region of micrometer as a unit, for example, a region of 100 μm².

The basic forms refer to elements of convexes defined by the average height and the average diameter. The average height is a height determined by measuring the height of basic forms constituting fine convexes defined above each at least once for basic forms of three or more convexes and arithmetically averaging the measured values. The average diameter is a diameter determined by measuring the diameter of basic forms constituting fine convexes defined above each at least once for basic forms of three or more convexes and arithmetically averaging the measured values.

Regarding elements comprising basic forms constituting the convexes, there are two cases, that is, a case where the elements each substantially independently form convexes and a case where the elements are mutually substantially connected, for example, like a strip, or as a mass to form convexes. Whether the elements comprising basic forms are present independently of each other or are mutually connected is judged based on the shape relationship between elements determined from a surface image and a sectional image taken with a scanning electron microscope.

The expression “substantially irregularly” as used herein means that the basic forms of convexes are neither formed on the surface of the base material in a calculated artificial distribution, nor distributed in a size suitable for developing macroscopic optical properties in a diffraction grating form or a photonic crystal form artificially or by self-organization, but are distributed substantially randomly on the surface of the base material. In substantially irregular arrangements of basic forms of Convexes according to the present invention, in some cases, several to several tens of basic forms of convexes are incidentally distributed on a micrometer scale partially and with low frequency in a diffraction grating-like or photonic crystal-like form. This is an accidental product of which the size is much smaller than a size which exhibits macroscopic light diffraction effect- or photonic crystal structure-derived optical effect.

In the antireflection structure according to the present invention, preferably, the frequency distribution of the diameter of basic forms of said convexes is narrow.

In the antireflection structure according to the present invention, preferably, the frequency distribution of the diameter of basic forms of said convexes is narrow and such that the number of convexes which are different in diameter by not more than 75 nm from convexes of the highest frequency is not less than 70% of the number of convexes which are different in diameter by not more than 300 nm from convexes of the highest frequency.

In the antireflection structure according to the present invention, preferably, the proportion of the number of basic forms of said convexes not connected to each other to the total number of basic forms of said convexes is not less than 10%.

According to the present invention, there is provided an optical member comprising the above antireflection structure.

In a preferred embodiment of the optical member according to the present invention, the above antireflection structure is provided on a surface of a geometrical optical functional shape.

According to the present invention, there is provided a display device comprising the above antireflection structure.

In a preferred embodiment of the display device according to the present invention, the above antireflection structure is provided on a surface of a geometrical optical functional shape.

According to the present invention, there is provided a solar battery panel comprising the above antireflection structure.

In a preferred embodiment of the solar battery panel according to the present invention, the above antireflection structure is provided on a surface of a geometrical optical functional shape.

According to the present invention, there is provided a master for the formation of an antireflection structure having on its surface an antireflection face having fine convexes, wherein said master comprises: a base material; and fine convexes provided on said base material, and wherein 10 to 90% of the effective area of the antireflection face is accounted for by said convexes, and said convexes comprise basic forms which may be connected to each other, said basic forms have an average height of 30 nm to 200 nm and an average diameter of 80 nm to 400 nm, and said basic forms are substantially irregularly arranged on said antireflection face.

According to the present invention, there is provided a process for producing a master for the formation of an antireflection structure, said process comprising the steps of: in producing the above master, forming a substrate layer on the surface of a base material optionally by an alternate adsorption method; and then fixing fine particles on said substrate layer to form fine convexes.

In the process for producing a master for the formation of an antireflection structure according to the present invention, preferably, the formation of said substrate layer by the alternate adsorption method is carried out by using a combination of the step of immersing said base material in an aqueous positive electrolyte polymer solution with the step of immersing said base material in an aqueous negative electrolyte polymer solution.

Preferably, the process for producing a master for the formation of an antireflection structure according to the present invention comprises the step of depositing fine particles by applying a fine particle dispersion liquid onto said substrate layer.

In the process for producing a master for the formation of an antireflection structure according to the present invention, preferably, after the deposition of the fine particles, the fine particle-deposited surface is subjected to heat treatment and/or overcoating.

In the process for producing a master for the formation of an antireflection structure according to the present invention, preferably, the skirt part in basic forms of the convexes formed of the fine particles is not substantially in a reverse taper form.

Here the basic forms of convexes in a form which is not in a reverse taper form refers to convexes in a form similar to the form of a bowl, a mountain or the like, for example, convexes not in such a form that, when a spherical particle is placed on a certain plane, has a reversed taper skirt part defined by the spherical particle and the plane.

According to the present invention, there is provided a process for producing a replication mold from the above master, said process comprising: providing the above master; preparing a resin negative mold which has been formed, in a reversed shape relationship with the convexes of the master, using said master; preparing a metallic positive mold from said resin negative mold by metal plating; and preparing, by metal plating, a metallic negative mold as a replication mold for replicating an antireflection structure from said metallic positive mold prepared in the step just above.

The first antireflection structure according to the present invention is an antireflection structure having on its surface an antireflection face with fine concaves, wherein 10 to 90% of the effective area of the antireflection face is accounted for by said concaves, and said concaves comprise basic forms which may be connected to each other, said basic forms have an average depth of 30 nm to 200 nm and an average diameter of 80 nm to 400 nm, and said basic forms are substantially irregularly arranged on said antireflection face, whereby the antireflection structure has excellent antireflection properties.

In the first antireflection structure, according to microscopic observation, the concaves are substantially irregularly arranged, while, according to macroscopic observation with the naked eye, the concaves are substantially evenly arranged. Therefore, the antireflection structure is particularly excellent in the level of antireflection properties and its homogeneity.

The second antireflection structure according to the present invention is an antireflection structure having on its surface an antireflection face with fine convexes, wherein 10 to 90% of the effective area of the antireflection face is accounted for by said convexes, and said convexes comprise basic forms which may be connected to each other, said basic forms have an average height of 30 nm to 200 nm and an average diameter of 80 nm to 400 nm, and said basic forms are substantially irregularly arranged on said antireflection face, whereby the antireflection structure has excellent antireflection properties.

In the second antireflection structure, according to microscopic observation, the convexes are substantially irregularly arranged, while, according to macroscopic observation with the naked eye, the convexes are substantially evenly arranged. Therefore, the antireflection structure is particularly excellent in the level of antireflection properties and its homogeneity.

The optical member comprising the first antireflection structure or second antireflection structure according to the present invention can effectively prevent light reflection. For example, in the case of an optical member for information display such as display devices, the visibility can be improved, and, in the case of a light receiving optical member such as solar battery panels, the efficiency for light utilization can be improved.

The antireflection structure according to the present invention can easily be produced from a predetermined replication mold. Specifically, a number of optical members having an antireflection structure can be replicated by providing a replication mold capable of forming the above predetermined antireflection structure and shaping the antireflection structure using this replication mold. According to this method, optical members having an antireflection structure of a substantially identical shape can be produced from a single replication mold.

Thus, as compared with the method in which, for each product, coating or vapor deposition is carried out, or a diffraction grating is prepared, optical members having a predetermined antireflection structure can be produced very stably in an easy and low-cost manner.

Further, in the present invention, also for optical base materials having a complicated surface shape, a predetermined antireflection structure can easily be formed.

### BRIEF DESCRIPTION OF THE DRAWINGS

FIG. 1 is a cross-sectional view of a preferred embodiment of a fine convex-type mold for the formation of a first antireflection structure according to the present invention;

FIG. 2 is a schematic diagram illustrating a preferred production process of a master and a replication mold for the formation of a first antireflection structure according to the present invention;

FIG. 3 is a typical view of basic forms of a first antireflection structure according to the present invention;

FIG. 4 is a cross-sectional view of a preferred embodiment of a second antireflection structure according to the present invention;

FIG. 5 is a schematic diagram illustrating a preferred production process of a replication mold for the formation of a second antireflection structure according to the present invention; and

FIG. 6 is a typical diagram of basic forms of a second antireflection structure according to the present invention.

### BEST MODE FOR CARRYING OUT THE INVENTION

A1. First Antireflection Structure The first antireflection structure according to the present invention is an antireflection structure having on its surface an antireflection face with fine concaves, wherein 10 to 90%, preferably 25 to 75%, of the effective area of the antireflection face is accounted for by said concaves, and said concaves comprise basic forms which may be connected to each other, said basic forms have an average depth of 30 nm to 200 nm, preferably 60 nm to 180 nm, and an average diameter of 80 nm to 400 nm, preferably 100 nm to 300 nm, and said basic forms are substantially irregularly arranged on said antireflection face.

The fine concaves refer to concaves formed of basic forms defined below and formed on a surface, as a reference surface, of a base material which can be regarded as substantially flat over a region of micrometer as a unit, for example, a region of 100 μm².

The basic forms refer to elements of concaves defined by the average depth and the average diameter. The average depth is a depth determined by measuring the depth of basic forms constituting fine concaves defined above each at least once for basic forms of three or more concaves and arithmetically averaging the measured values. The average diameter is a diameter determined by measuring the diameter of basic forms constituting fine concaves defined above each at least once for basic forms of three or more concaves and arithmetically averaging the measured values.

Regarding elements comprising basic forms constituting the concaves, there are two cases, that is, a case where the elements each substantially independently form concaves and a case where the elements are mutually substantially connected, for example, like a strip, or as a mass to form concaves. Whether the elements comprising basic forms are present independently of each other or are mutually connected is judged based on the shape relationship between elements determined from a surface image and a sectional image taken with a scanning electron microscope.

The expression “substantially irregularly” as used herein means that the basic forms of concaves are neither formed on the surface of the base material in a calculated artificial distribution, nor distributed in a size suitable for developing macroscopic optical properties in a diffraction grating form or a photonic crystal form artificially or by self-organization, but are distributed substantially randomly on the surface of the base material. In substantially irregular arrangements of basic forms of concaves according to the present invention, in some cases, several to several tens of basic forms of concaves are incidentally distributed on a micrometer scale partially and with low frequency in a diffraction grating-like or photonic crystal-like form. This is an accidental product of which the size is much smaller than a size which exhibits a macroscopic light diffraction effect or a photonic crystal structure-derived optical effect.

The average height and average diameter of basic forms may be determined, for example, with a surface roughness tester, a probe microscope, or a microinterferometer. However, the use of a scanning electron microscope is preferred because it is considered that the actual shape is more correctly reflected. Both the average depth and the average diameter are an arithmetic average value, and measurement should be made once for each of at least three basic forms. Although the number of basic forms to be measured varies depending upon the degree of distribution of basic forms, preferably, measurement is made at least once for each of five or more of basic forms to obtain data which are then averaged, and, more preferably, measurement is made at least once for each of 20 or more of basic forms to obtain data which are then averaged.

When the proportion of the concaves occupying the antireflection face is less than 10% of the effective area of the antireflection face, the amount of the concaves is so small that, disadvantageously, the structure does not substantially function as an antireflection structure. On the other hand, when the proportion of the concaves occupying the antireflection face exceeds 90% of the effective area of the antireflection face, the amount of the concaves is so large that, disadvantageously, the structure does not substantially function as an antireflection structure. When the average depth of the basic forms is less than 30 nm, the depth of the concaves is too small for the structure to substantially function as an antireflection structure. On the other hand, when the average depth of the basic forms exceeds 200 nm, the depth of the concaves is so large that unnecessary light scattering is disadvantageously developed. When the average diameter is less than 80 nm, the diameter of the concaves is so small that, disadvantageously, the antireflection properties are unsatisfactory. On the other hand, when the average diameter exceeds 400 nm, the diameter of the concaves is so large that unnecessary light scattering is disadvantageously developed. The value obtained by dividing the average depth by the average diameter is preferably 0.075 to 2.5, particularly preferably 0.2 to 1.8. When this value is less than 0.075, the function as the antireflection structure is unsatisfactory. On the other hand, concaves in which the value obtained by dividing the average depth by the average diameter exceeds 2.5 cannot be formed without difficulties for production reasons.

Further, regarding the concaves, it is preferred that the size is uniform, that is, the frequency distribution of the diameter of the concaves be narrow. Accordingly, the concaves are preferably such that the frequency distribution of the diameter of the basic form of said concaves is narrow and such that the number of concaves which are different in diameter by not more than 75 nm from concaves of the highest frequency is not less than 70%, particularly not less than 80%, of the number of concaves which are different in diameter by not more than 300 nm from concaves of the highest frequency.

Further, the proportion of said concaves not connected to each other to the total number of the concaves is preferably not less than 10%, particularly preferably not less than 20%.

In the above antireflection structure, according to microscopic observation, the concaves are substantially irregularly arranged, while, according to macroscopic observation with the naked eye, the concaves are substantially evenly arranged. Therefore, the antireflection structure is particularly excellent in the level of antireflection properties and its homogeneity.

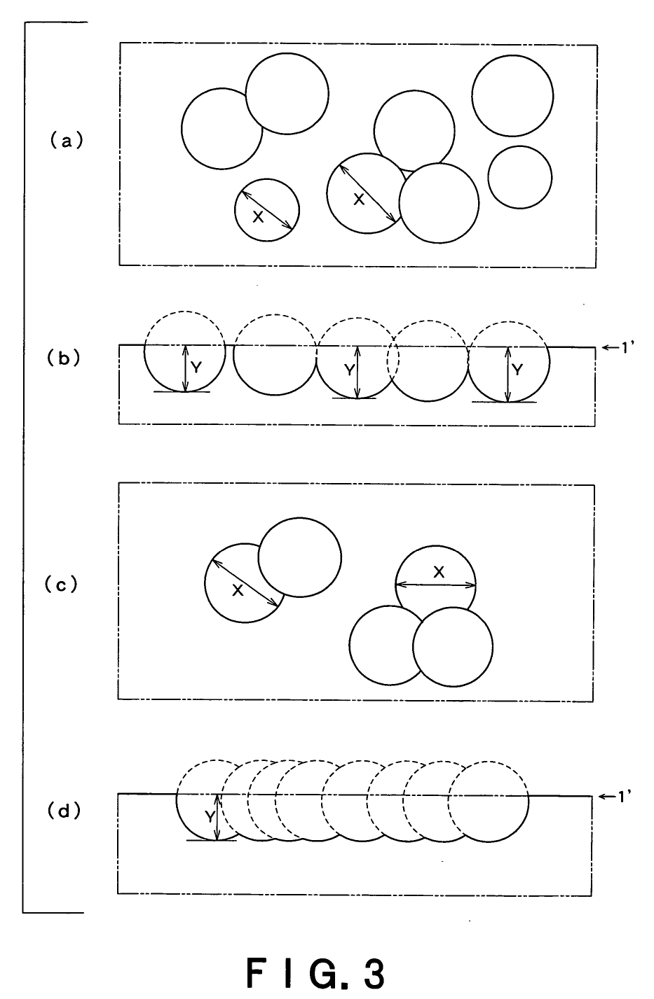

FIG. 3 is a typical diagram showing basic forms constituting concaves according to the present invention, wherein FIG. 3(a) is a plan view of substantially independent basic forms as observed from the top surface, FIG. 3(b) is a cross-sectional view of a side face of substantially independent basic forms, FIG. 3(c) is a plan view of substantially connected basic forms as observed from the top surface, and FIG. 3(d) is a cross-sectional view of a side face of substantially connected basic forms. FIGS. 3(a) to 3(d) show diameter X of basic forms and depth Y (depth from reference plane 1′) of basic forms in the case where the basic forms are completely independently of each other, and in the case where a plurality of basic forms are connected to each other to form a lump or a strip-like material.

A2. Master for Forming First Antireflection Structure

The master for the formation of an antireflection structure according to the present invention has on its surface an antireflection face having fine concaves, wherein said master comprises: a base material; and fine concaves provided on said base material, and wherein 10% to 90% of the effective area of the antireflection face is accounted for by said concaves, and said concaves comprise basic forms which may be connected to each other, said basic forms have an average depth of 30 nm to 200 nm and an average diameter of 80 nm to 400 nm, and said basic forms are substantially irregularly arranged on said antireflection face.

This master has on its surface information about fine concaves in the antireflection structure according to the present invention. The antireflection structure in the present invention can be regarded as being formed from a part or the whole of information about the fine concaves on the master surface, or from a combination of a plurality of masters.

Accordingly, as with the antireflection structure, in the master according to the present invention, the proportion of the concaves in the antireflection face is in the range of 10% to 90%, preferably in the range of 25% to 75%, of the effective area of the antireflection face. The concaves are formed of basic forms which may be connected to each other. For the basic forms, the average depth is 30 nm to 200 nm, preferably 60 nm to 180 nm, and the average diameter is 80 nm to 400 nm, preferably 100 nm to 300 nm, the value obtained by dividing the average depth by the average diameter is preferably in the range of 0.075 to 2.5, particularly preferably in the range of 0.2 to 1.8, and the basic forms are substantially irregularly arranged on the antireflection face.

A3. Production Process of Master

The process for producing a master for the formation of an antireflection structure according to the present invention comprises the step of, in producing the master, forming a substrate layer on the surface of a base material optionally by an alternate adsorption method; then fixing fine particles on said substrate layer to form fine convexes, and preparing a resin negative mold which has been formed, in a reversed shape relationship with the fine convexes.

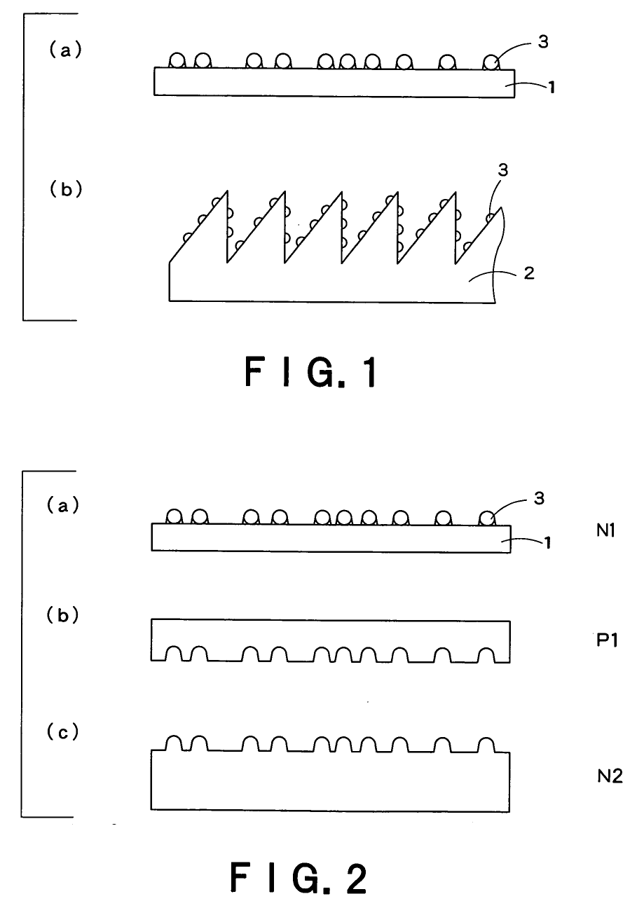

A specific example of a preferred production process of the master will be described, if necessary, with reference to FIGS. 1 and 2.

(1) Base Material

Any base material may be used in the present invention. Preferably, however, a base material on which a substrate layer can easily be formed by an alternate adsorption method is used. Such base materials include inorganic materials such as glass, metals such as nickel, and organic materials such as various polymeric compounds. This base material may be transparent or opaque. When an ultraviolet curable resin is applied in producing the master and/or replication mold (which will be described in detail below) according to the present invention, the use of a transparent base material is preferred because exposure through the base material side is possible.

This base material may be a plate (1), a sheet or a film having a substantially flat plane as shown in FIG. 1(a), or alternatively may be a base material having a regular or irregular or geometric surface, for example, a base material of which the surface is in a linear, curved, flat, curved-surface and/or concave-convex form, for example, that provides certain optical properties. For example, various shapes corresponding to contemplated optical members, for example, Fresnel lenses, lenticular lenses, lens arrays, hologram sheets, prisms, light guide plates, light diffusing sheets, convex lens-like or concave lens-like base materials may be utilized. Further, this base material may also be in a cyclindrical or columnar form such as metallic rolls or metallic cylinders.

FIG. 1(b) shows a process for producing a master for an optical member in which a base material sheet (2) may be in a Fresnel lens form and the antireflection structure according to the present invention is provided on a surface of a Fresnel lens.

(2) Alternate Adsorption Method

The substrate layer may be formed by an alternate adsorption method. The alternate adsorption method refers to a method in which thin films of a positive electrolyte polymer and thin films of a negative electrolyte polymer are alternately formed on a substrate by alternately immersing a base material in an aqueous solution of a positive electrolyte polymer and an aqueous solution of a negative electrolyte polymer. In this alternate adsorption method, in general, if necessary, a multilayer structure having a number of layers according to the number of times of immersion can be formed by alternately immersing a substrate, to the surface of which initial charges have been applied prior to the immersion, in an aqueous solution of a positive electrolyte polymer and an aqueous solution of a negative electrolyte polymer.

The number of times of immersion in an aqueous solution of a positive electrolyte polymer and the number of times of immersion in an aqueous solution of a negative electrolyte polymer may be properly determined depending, for example, upon properties required as a substrate layer and the thickness of the substrate layer.

The properties required as the substrate layer refer to properties that apply charges in an amount required for mainly depositing a necessary amount of fine particles which will be described later to the base material. In general, there is a tendency that the amount of fine particles which can be deposited increases with increasing the thickness of the substrate layer, that is, increasing the number of times of immersion in an aqueous solution of an electrolyte polymer.

The productivity advantageously increases with decreasing the thickness of the substrate layer, that is, with decreasing the number of times of immersion in the electrolyte polymer. However, it is empirically known that, there is a tendency that, when fine particles having weak adsorptive force are used, a relatively thick substrate layer is preferred. A conventional method for increasing the thickness of the substrate layer other than the method in which the number of times of immersion is increased is to regulate the hydrogen ion concentration or ion strength of the aqueous solution of an electrolyte polymer, thereby enhancing the thickness of the film formed per unit immersion.

The thickness of the substrate layer is generally not more than 50 nm, particularly preferably not more than 30 nm. The number of times of immersion in the aqueous solution of the positive electrolyte polymer and the number of times of immersion in the aqueous solution of the negative electrolyte polymer each are preferably not more than 20, particularly preferably not more than 10.

Preferred positive electrolyte polymers include polyallylamine hydrochlorides, polypyrrole, polyaniline, polyethyleneimine, polylysine, polydiallyldimethyl ammonium chloride, polyvinylpyridine, and copolymers containing these monomer components. Preferred negative electrolyte polymers include polyacrylic acid, polystyrenesulfonic acid, polymethacrylic acid, and copolymers containing these monomer components.

When the substrate layer has been formed by the alternate adsorption method, the adhesive strength between the substrate layer and the adhesive strength of the fine particles which will be described later can be improved and a deposition state of fine particles onto the substrate layer preferable as the antireflection structure can be realized. For example, when fine particles with charges applied thereto are used, it is recognized that the adhesive strength can be improved by interaction between the charges on the surface of the substrate layer and the charges of the fine particles.

In some cases, the polymer adsorption layer which functions as the substrate layer can be formed on the base material by immersing the base material in any one of the positive aqueous electrolyte polymer solution and the negative aqueous electrolyte polymer solution only once. In fact, this method can be said to realize the highest productivity. In the present invention, this case where immersion in the aqueous electrolyte polymer solution only once suffices for contemplated results is also embraced in the alternate adsorption method for the sake of simplicity.

(3) Fine Particles

For example, organic or inorganic various fine particle materials may be mentioned as fine particles (3) usable in the present invention. In the present invention, for example, silica fine particles, (meth)acrylic polymeric fine particles, styrenic polymeric fine particles, and styrene-butadiene polymeric fine particles are preferably used. The term “meth(acryl)” refers to both “acryl” and “methacryl.” Since the fine particles constitute basic forms of fine concaves formed in the antireflection structure and master according to the present invention, the size and shape thereof may be determined according to the contemplated antireflection structure and master. When the antireflection structure and master according to the present invention which are uniform in size of the basic forms are contemplated, the use of fine particles having a uniform particle diameter is preferred. When an antireflection structure in which two basic forms different from each other in size are present as a mixture is contemplated, relatively large fine particles having uniform particle diameters and relatively small fine particles having uniform particle diameters can be used in combination.

In order to prevent agglomeration or continuation of a plurality of fine particles, electrification of each fine particle is preferred from the viewpoints of causing repulsive force between the fine particles and improving the adhesion force between the fine particles and the substrate layer.

(4) Heat Treatment and Overcoat Treatment

After the adhesion of the fine particles, preferably, the surface with fine particles adhered thereto is heat treated and/or overcoated. This can improve the adhesive strength of the fine particles and, at the same time, the reversed taper shape in the skirt part of the convexes constituted by fine particles is eliminated, and, thus, the production of a replication mold from this master becomes easy. Heating conditions and overcoat treatment conditions may be determined by taking into consideration, for example, the type, details and adhesive strength of the fine particles and/or the substrate. For example, when polymeric fine particles are used as fine particles, heating conditions are 200° C. or below, particularly preferably 40° C. to 150° C.

Overcoat materials usable in the overcoat treatment include polymer materials, condensates of metal chlorides, condensates of metal alkoxides, and alternate adsorption films, preferably alternate adsorption films which are excellent in film thickness controllability, as well as in conformability (that is, a property by which the overcoat material is adhered so as to conform evenly along the surface shape of the object to be coated). This preferred alternate adsorption film may be formed, for example, by the alternate adsorption method using the positive electrolyte polymer and the negative electrolyte polymer.

Particularly preferred overcoat materials include fluoro materials such as fluoropolymer materials, fluorometal chloride condensates, and fluoro alternate adsorption films. Overcoat materials comprising such fluoromaterials are particularly preferred because they can impart very good antifouling properties and separability to the base material. The overcoat treatment may be carried out once or alternatively may be repeated a plurality of times. Further, the overcoat layer may be a double layer-type overcoat layer formed, for example, by coating a fluoro silane coupling agent for imparting antifouling properties and separability onto various alternate adsorption films for eliminating a reversed taper shape. In particular, antifouling properties, separability, and durability can be significantly improved by repeating overcoat treatment using a fluoro material a plurality of times.

A base material having fine convexes on its surface as shown in FIG. 1(a), FIG. 1(b), or FIG. 2(a) is formed by fixing fine particles by the above method.

(5) Preparation of Resin Master

In the present invention, after the formation of the fine convexes, a resin master which is in a reversed shape relationship with the fine convexes is prepared. For example, a mold (N1) having fine convexes on its surface shown in FIG. 2(a) is used for the formation of a master (P1) which is in a reversed shape relationship with the convexes as shown in FIG. 2(b).

This mold (P1) may be produced, for example, by applying an uncured ultraviolet curable resin onto the (N1) in its convex formed surface, applying, in this state, ultraviolet light to the uncured ultraviolet curable resin to cure the resin, and separating the cured resin from (N1). For example, preferably, a method may be adopted in which an uncured ultraviolet curable resin is dropped on (N1) in its convex formed surface, a suitable resin film, for example, polyethylene terephthalate, is then applied by spreading the film over the whole surface of the ultraviolet curable resin, while bringing the resin film into intimate contact with the ultraviolet curable resin by a laminator such as a roller, ultraviolet light is then applied from the backside of the film to cure the ultraviolet curable resin, and the resin which has been cured together with the film is then separated from the surface of the master.

A concave face which is in a reversed shape relationship with the convexes in the above (N1) is formed on the separated face of the cured resin. Thus, the master according to the present invention can be prepared.

As described above, a method which comprises applying an ultraviolet curable resin to a mold face with convexes or concaves in the master, covering the applied ultraviolet curable resin with a film, applying ultraviolet light to the resin to cure the resin, and separating the cured resin together with the film from the mold surface to copy the shape of the mold surface will be referred to as a 2P method (a photopolymerization method) in the present specification.

When the master for antireflection structure formation is cylindrical or columnar and is durable, the resin master can be prepared by a roll-to-roll process. The mass production-type resin master may be used not only as a master but also as a final product.

A4. Production Process of Replication Mold

The production process of a replication mold according to the present invention is a process for producing a replication mold from the above master and comprises providing the above master and preparing a metallic negative mold for replicating an antireflection structure according to the present invention from this master by a metal plating method.

The replication mold according to the present invention may be produced by providing a master (P1) shown in FIG. 2(b) and preparing a metallic negative mold (N2) shown in FIG. 2(c) from this master by a metal plating method. In plating the master (P1) with a metal, for example, a method may be adopted in which an electrically conductive thin film is formed, for example, by vapor deposition onto the master (P1) in its surface with predetermined concaves, and metal plating or electrocasting may be carried out on this thin film. Thereafter, the master (P1) may be separated from this plating part to prepare a metallic negative mold (N2) having predetermined convexes on its surface shown in FIG. 2(c).

The conductive thin film formed on the surface of the master (P1) may be formed of, for example, nickel, chromium, gold or ITO. In the present invention, nickel is particularly preferred. The plating provided on this thin film is preferably a plating which has good adhesive strength to this thin film, for example, particularly preferably a nickel plating. Methods conducted before plating include those described in Japanese Patent Laid-Open No. 173791/2002, for example, the step of alkali degreasing in which the material is immersed in an alkali degreasing liquid for a short period of time and is then electrolyzed, the step of water washing, the step of acid activation in which the material is immersed in an acid, the step of drying, and the step of peeling film formation.

The negative mold (N2) shown in FIG. 2(c) is such that the fine convex structure formed on the surface of the above (N1) is reproduced as a metal.

A plurality of negative molds (N2) having substantially identical convex information can be prepared by repeating the steps shown in FIG. 2(b) and FIG. 2(c) a plurality of time using the same master (P1). In this case, even when the negative mold (N2) is unsuitable for use as a result of damage or wear, the usable mold can easily be replaced.

This metallic negative mold (N2) may be used in replicating the antireflection structure and the optical member having this antireflection structure according to the present invention. Accordingly, the metal plating preferably has strength and durability high enough for the fine surface structure to be well reproduced in the replication. To this end, the metal plating is preferably formed in a thickness of at least about 0.1 to 3 mm.

In replicating the antireflection structure and the optical member having this antireflection structure according to the present invention, the optical member material can be shaped by this metallic negative mold (N2). The shaping can be carried out by a method in which a molten resin or softened resin is extruded or injected onto the surface of the metallic negative mold (N2) and the molten resin or softened resin may be shaped and cured under predetermined pressure and temperature conditions. Further, a method may also be adopted in which an ultraviolet curable resin is applied to this metallic negative mold (N2) and can be cured by exposure to ultraviolet light.

Thus, a number of the antireflection structure and the optical member having this antireflection structure according to the present invention can be replicated.

A large number of Fresnel lenses with the antireflection structure according to the present invention may be replicated, for example, by providing, as (N1) shown in FIG. 2(a), a substrate in a Fresnel lens form with fine particles deposited thereon shown in FIG. 1(b) and carrying out the steps shown in FIGS. 2(b) to 2(c).

Thus, the antireflection structure according to the present invention can easily be produced from a predetermined replication mold. Specifically, a number of optical members having an antireflection structure may be replicated by providing a replication mold capable of forming the above predetermined antireflection structure, and shaping the antireflection structure using this replication mold. Accordingly, the present invention can produce an optical member with a predetermined antireflection structure very stably in an easy and low-cost manner.

Further, according to the present invention, a predetermined antireflection structure can easily be formed even when the optical base material has a complicated surface shape.

All of N1, P1 and N2 shown in FIGS. 2(a) to 2(c) are in a flat sheet form. However, it should be noted that N1, P1 and N2 are not always required to be in a flat sheet form. For example, N1, P1 and N2 may be in a curved surface form in which the surface is curved with a certain curvature. In particular, when N2 as a negative mold is curved with a certain curvature to constitute a cylindrical form and an antireflection structure of the negative mold is continuously provided on the outer peripheral face of the cylinder, a continuous antireflection structure can be formed on the surface of the base material by pressing the cylindrical N2 against the base material for antireflection structure formation while rotating the cylindrical N2 to shape the base material surface. The method using the cylindrical N2 is particularly advantageous when the antireflection structure according to the present invention is continuously formed on a long base material. When a plurality of cylindrical N2 different from each other in antireflection structure are provided and are pressed on the whole surface or a part of one side or both sides of the base material for antireflection structure formation to shape the base material surface, a plurality of different antireflection structures according to the present invention can be formed on one side or both sides of a single base material.

A5. Optical Member

The optical member according to the present invention has the above antireflection structure.

The optical member according to the present invention has the above antireflection structure on its surface. The shape or form of the optical member with the antireflection structure formed thereon per se may be any one. Specifically, the optical member according to the present invention having the above antireflection structure may be any one, for example, those having a regular, irregular, geometric optical functional surface and/or shape, for example, those having, on the surface thereof, a linear, curved line, flat, curved face and/or convex-concave shape, particularly various shapes corresponding to the contemplated optical member, for example, Fresnel lenses, lenticular lenses, lens arrays, hologram sheets, prisms, light guide plates, light diffusing sheets, convex lens-like or concave lens-like shapes that can provide predetermined optical properties.

The optical member according to the present invention can be applied to various applications, for example, display devices and solar battery panels.

The optical member having the antireflection structure can effectively prevent light reflection. For example, in the case of optical members for information display such as display devices, the visibility is improved. On the other hand, in the case of light receiving optical members such as solar battery panels, efficiency for light utilization can be improved.

B1. Second Antireflection Structure

The second antireflection structure according to the present invention is an antireflection structure having an antireflection face having fine convexes on its surface, wherein 10% to 90%, preferably 25% to 75%, of the effective area of the antireflection face is accounted for by said convexes, and said convexes comprise basic forms which may be connected to each other, said basic forms have an average height of 30 nm to 200 nm, preferably 60 nm to 180 nm, and an average diameter of 80 nm to 400 nm, preferably 100 nm to 300 nm, and said basic forms are substantially irregularly arranged on said antireflection face.

The fine convexes refer to convexes formed of basic forms defined below and formed on a surface, as a reference surface, of a base material which can be regarded as substantially flat over a region of micrometer as a unit, for example, a region of 100 μm².

The basic forms refer to elements of convexes defined by the average height and the average diameter. The average height is a height determined by measuring the height of basic forms constituting fine convexes defined above each at least once for basic forms of three or more convexes and arithmetically averaging the measured values. The average diameter is a diameter determined by measuring the diameter of basic forms constituting fine convexes defined above each at least once for basic forms of three or more convexes and arithmetically averaging the measured values.

Regarding elements comprising basic forms constituting the convexes, there are two cases, that is, a case where the elements each substantially independently form convexes and a case where the elements are mutually substantially connected, for example, like a strip, or as a mass to form convexes. Whether the elements comprising basic forms are present independently of each other or are mutually connected is judged based on the shape relationship between elements determined from a surface image and a sectional image taken with a scanning electron microscope.

The expression “substantially irregularly” as used herein means that the basic forms of convexes are neither formed on the surface of the base material in a calculated artificial distribution, nor distributed in a size suitable for developing macroscopic optical properties in a diffraction grating form or a photonic crystal form artificially or by self-organization, but are distributed substantially randomly on the surface of the base material. In substantially irregular arrangements of basic forms of convexes according to the present invention, in some cases, several to several tens of basic forms of convexes are incidentally distributed on a micrometer scale partially and with low frequency in a diffraction grating-like or photonic crystal-like form. This is an accidental product of which the size is much smaller than a size which exhibits a macroscopic light diffraction effect or a photonic crystal structure-derived optical effect.

The average height and average diameter of basic forms may be determined, for example, with a surface roughness tester, a probe microscope, or a microinterferometer. However, the use of a scanning electron microscope is preferred because it is considered that the actual shape is more correctly reflected. Both the average height and the average diameter are an arithmetic average value, and measurement should be made once for each of at least three basic forms. Although the number of basic forms to be measured varies depending upon the degree of distribution of basic forms, preferably, measurement is made at least once for each of five or more of basic forms to obtain data which are then averaged, and, more preferably, measurement is made at least once for each of 20 or more of basic forms to obtain data which are then averaged.

When the proportion of the convexes occupying the antireflection face is less than 10% of the effective area of the antireflection face, the amount of the convexes is so small that, disadvantageously, the structure does not substantially function as an antireflection structure. On the other hand, when the proportion of the convexes occupying the antireflection face exceeds 90% of the effective area of the antireflection face, the amount of the convexes is so large that, disadvantageously, the structure does not substantially function as an antireflection structure. When the average height of the basic forms is less than 30 nm, the height of the convexes is too small for the structure to substantially function as an antireflection structure. On the other hand, when the average height of the basic forms exceeds 200 nm, the height of the convexes is so large that unnecessary light scattering is disadvantageously developed. When the average diameter is less than 80 nm, the diameter of the convexes is so small that, disadvantageously, the antireflection properties are unsatisfactory. On the other hand, when the average diameter exceeds 400 nm, the diameter of the convexes is so large that unnecessary light scattering is disadvantageously developed. The value obtained by dividing the average height by the average diameter is preferably 0.075 to 2.5, particularly preferably 0.2 to 1.8. When this value is less than 0.075, the function as the antireflection structure is unsatisfactory. On the other hand, convexes in which the value obtained by dividing the average height by the average diameter exceeds 2.5 cannot be formed without difficulties for production reasons.

Further, regarding the convexes, it is preferred that the size is uniform, that is, the frequency distribution of the diameter of the convexes be narrow. Accordingly, the convexes are preferably such that the frequency distribution of the diameter of the basic form of said convexes is narrow and such that the number of convexes which are different in diameter by not more than 75 nm from convexes of the highest frequency is not less than 70%, particularly not less than 80%, of the number of convexes which are different in diameter by not more than 300 nm from convexes of the highest frequency.

Further, the proportion of said convexes not connected to each other to the total number of the convexes is preferably not less than 10%, particularly preferably not less than 20%.

In the above antireflection structure, according to microscopic observation, the convexes are substantially irregularly arranged, while, according to macroscopic observation with the naked eye, the convexes are substantially evenly arranged. Therefore, the antireflection structure is particularly excellent in the level of antireflection properties and its homogeneity.

FIG. 6 is a typical diagram showing basic forms constituting convexes according to the present invention, wherein FIG. 6(a) is a plan view of substantially independent basic forms as observed from the top surface, FIG. 6(b) is a cross-sectional view of a side face of substantially independent basic forms, FIG. 6(c) is a plan view of substantially connected basic forms as observed from the top surface, and FIG. 6(d) is a cross-sectional view of a side face of substantially connected basic forms. FIGS. 6(a) to 6(d) show diameter X of basic forms and height Y (height from reference plane 1′) of basic forms in the case where the basic forms are completely independent of each other, and in the case where a plurality of basic forms are connected to each other to form a lump or a strip-like material.

B2. Master for Forming Antireflection Structure

The master for the formation of an antireflection structure according to the present invention has an antireflection face having on its surface fine convexes, wherein said master comprises: a base material; and fine convexes provided on said base material, and wherein 10% to 90% of the effective area of the antireflection face is accounted for by said convexes, and said convexes comprise basic forms which may be connected to each other, said basic forms have an average height of 30 nm to 200 nm and an average diameter of 80 nm to 400 nm, and said basic forms are substantially irregularly arranged on said antireflection face.

This master has on its surface information about fine convexes in the antireflection structure according to the present invention. The antireflection structure in the present invention can be regarded as being formed from a part or the whole of information about the fine convexes on the master surface, or from a combination of a plurality of masters.

Accordingly, as with the antireflection structure, in the master according to the present invention, the proportion of the convexes in the antireflection face is in the range of 10% to 90%, preferably in the range of 25% to 75%, of the effective area of the antireflection face. The convexes are formed of basic forms which may be connected to each other. For the basic forms, the average height is 30 nm to 200 nm, preferably 60 nm to 180 nm, and the average diameter is 80 nm to 400 nm, preferably 100 nm to 300 nm, the value obtained by dividing the average height by the average diameter is preferably in the range of 0.075 to 2.5, particularly preferably in the range of 0.2 to 1.8, and the basic forms are substantially irregularly arranged on the antireflection face.

B3. Production Process of Master

This master can be produced by any production process. Preferably, the master is produced by the following production process of a master.

Accordingly, the process for producing a master for the formation of an antireflection structure according to the present invention comprises the steps of, in producing the master, forming a substrate layer on the surface of a base material optionally by an alternate adsorption method; and then fixing fine particles on said substrate layer to form fine convexes.

A particularly preferred production process of a master comprises combining the step of immersing the base material in an aqueous positive electrolyte polymer solution with the step of immersing the base material in an aqueous negative electrolyte polymer solution to form a substrate layer by the alternative adsorption method and the step of applying a fine particle dispersion liquid onto the substrate layer to deposit the fine particles to the substrate layer. In this process, after the deposition of the fine particles, the fine particle-deposited surface is heat treated and/or overcoated.

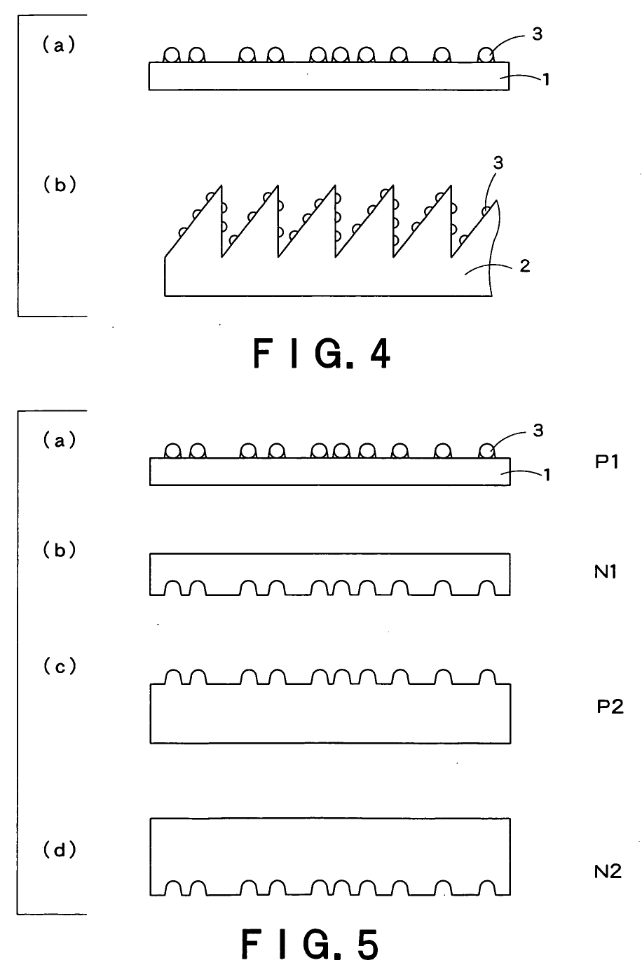

A specific example of a preferred production process of the master will be described, if necessary, with reference to FIG. 4.

(1) Base Material

Any base material may be used in the present invention. Preferably, however, a base material on which a substrate layer can easily be formed by an alternate adsorption method is used. Such base materials include inorganic materials such as glass, metals such as nickel, and organic materials such as various polymeric compounds. This base material may be transparent or opaque. When an ultraviolet curable resin is applied in producing the master and/or replication mold (which will be described in detail below) according to the present invention, the use of a transparent base material is preferred because exposure through the base material side is possible.

This base material may be a plate (1), a sheet or a film having a substantially flat plane as shown in FIG. 4(a), or alternatively may be a base material having a regular or irregular or geometric surface, for example, a base material of which the surface is in a linear, curved, flat, curved-surface and/or convex-concave form, for example, that provides certain optical properties. For example, various shapes corresponding to contemplated optical members, for example, Fresnel lenses, lenticular lenses, lens arrays, hologram sheets, prisms, light guide plates, light diffusing sheets, convex lens-like or concave lens-like base materials may be utilized. Further, this base material may also be in a cylindrical or columnar form such as metallic rolls or metallic cylinders.

FIG. 4(b) shows a process for producing a master for an optical member in which a base material sheet (2) may be in a Fresnel lens form and the antireflection structure according to the present invention is provided on a surface of a Fresnel lens.

(2) Alternative Adsorption Method

The substrate layer may be formed by an alternative adsorption method. The alternate adsorption method refers to a method in which thin films of a positive electrolyte polymer and thin films of a negative electrolyte polymer are alternately formed on a substrate by alternately immersing a base material in an aqueous solution of a positive electrolyte polymer and an aqueous solution of a negative electrolyte polymer. In this alternate adsorption method, in general, if necessary, a multilayer structure having a number of layers according to the number of times of immersion can be formed by alternately immersing a substrate, to the surface of which initial charges have been applied prior to the immersion, in an aqueous solution of a positive electrolyte polymer and an aqueous solution of a negative electrolyte polymer.

The number of times of immersion in an aqueous solution of a positive electrolyte polymer and the number of times of immersion in an aqueous solution of a negative electrolyte polymer may be properly determined depending, for example, upon properties required as a substrate layer and the thickness of the substrate layer.

The properties required as the substrate layer refer to properties that apply charges in an amount required for mainly depositing a necessary amount of fine particles which will be described later to the base material. In general, there is a tendency that the amount of fine particles which can be deposited increases with increasing the thickness of the substrate layer, that is, increasing the number of times of immersion in an aqueous solution of an electrolyte polymer.

The productivity advantageously increases with decreasing the thickness of the substrate layer, that is, with decreasing the number of times of immersion in the electrolyte polymer. However, it is empirically known that, there is a tendency that, when fine particles having weak adsorptive force are used, a relatively thick substrate layer is preferred. A conventional method for increasing the thickness of the substrate layer other than the method in which the number of times of immersion is increased is to regulate the hydrogen ion concentration or ion strength of the aqueous solution of an electrolyte polymer, thereby enhancing the thickness of the film formed per unit immersion.

The thickness of the substrate layer is generally not more than 50 nm, particularly preferably not more than 30 nm. The number of times of immersion in the aqueous solution of the positive electrolyte polymer and the number of times of immersion in the aqueous solution of the negative electrolyte polymer each are preferably not more than 20, particularly preferably not more than 10.

Preferred positive electrolyte polymers include polyallylamine hydrochlorides, polypyrrole, polyaniline, polyethyleneimine, polylysine, polydiallyidimethyl ammonium chloride, polyvinylpyridine, and copolymers containing these monomer components. Preferred negative electrolyte polymers include polyacrylic acid, polystyrenesulfonic acid, polymethacrylic acid, and copolymers containing these monomer components.

When the substrate layer has been formed by the alternative adsorption method, the adhesive strength between the substrate layer and the adhesive strength of the fine particles which will be described later can be improved and a deposition state of fine particles onto the substrate layer preferable as the antireflection structure can be realized. For example, when fine particles with charges applied thereto are used, it is recognized that the adhesive strength can be improved by interaction between the charges on the surface of the substrate layer and the charges of the fine particles.

In some cases, the polymer adsorption layer which functions as the substrate layer can be formed on the base material by immersing the base material in any one of the positive aqueous electrolyte polymer solution and the negative aqueous electrolyte polymer solution only once. In fact, this method can be said to realize the highest productivity. In the present invention, this case where immersion in the aqueous electrolyte polymer solution only once suffices for contemplated results is also embraced in the alternate adsorption method for the sake of simplicity.

(3) Fine Particles

For example, organic or inorganic various fine particle materials may be mentioned as fine particles (3) usable in the present invention. In the present invention, for example, silica fine particles, (meth)acrylic polymeric fine particles, styrenic polymeric fine particles, and styrene-butadiene polymeric fine particles are preferably used. The term “meth(acryl)” refers to both “acryl” and “methacryl.” Since the fine particles constitute basic forms of fine convexes formed in the antireflection structure and master according to the present invention, the size and shape thereof may be determined according to the contemplated antireflection structure and master. When the antireflection structure and master according to the present invention which are uniform in size of the basic forms are contemplated, the use of fine particles having a uniform particle diameter is preferred. When an antireflection structure in which two basic forms different from each other in size are present as a mixture is contemplated, relatively large fine particles having uniform particle diameters and relatively small fine particles having uniform particle diameters can be used in combination.

In order to prevent agglomeration or continuation of a plurality of fine particles, electrification of each fine particle is preferred from the viewpoints of causing repulsive force between the fine particles and improving the adhesion force between the fine particles and the substrate layer.

(4) Heat Treatment and Overcoat Treatment

After the adhesion of the fine particles, preferably, the surface with fine particles adhered thereto is heat treated and/or overcoated. This can improve the adhesive strength of the fine particles and, at the same time, the reversed taper shape in the skirt part of the convexes constituted by fine particles is eliminated, and, thus, the production of a replication mold from this master becomes easy. Heating conditions and overcoat treatment conditions may be determined by taking into consideration, for example, the type, details and adhesive strength of the fine particles and/or the substrate. For example, when polymeric fine particles are used as fine particles, heating conditions are 200° C. or below, particularly preferably 40° C. to 150° C.

Overcoat materials usable in the overcoat treatment include polymer materials, condensates of metal chlorides, condensates of metal alkoxides, and alternate adsorption films, preferably alternate adsorption films which are excellent in film thickness controllability, as well as in conformability (that is, a property by which the overcoat material is adhered so as to conform evenly along the surface shape of the object to be coated). This preferred alternate adsorption film may be formed, for example, by the alternate adsorption method using the positive electrolyte polymer and the negative electrolyte polymer.

Particularly preferred overcoat materials include fluoro materials such as fluoropolymer materials, fluorometal chloride condensates, and fluoro alternate adsorption films. Overcoat materials comprising such fluoro materials are particularly preferred because they can impart very good antifouling properties and separability to the base material. Further, the overcoat layer may be a double layer-type overcoat layer formed, for example, by coating a fluoro silane coupling agent for imparting antifouling properties and separability onto various alternate adsorption films for eliminating a reversed taper shape. The overcoat treatment may be carried out once or repeated a plurality of times. In particular, antifouling properties, separability, and durability can be significantly improved by repeating overcoat treatment using a fluoro material a plurality of times.

B4. Production Process of Replication Mold

The production process of a replication mold according to the present invention is a process for producing a replication mold from the above master and comprises providing the above master, preparing a resin negative mold which is in a reversed convex relationship with the master from the master, preparing a metallic positive mold from the resin negative mold by a metal plating method, and preparing a metallic negative mold as a replication mold for antireflection structure replication from the metallic positive mold prepared in the above step by a metal plating method.

A specific example of the production process of a replication mold according to the present invention will be described.

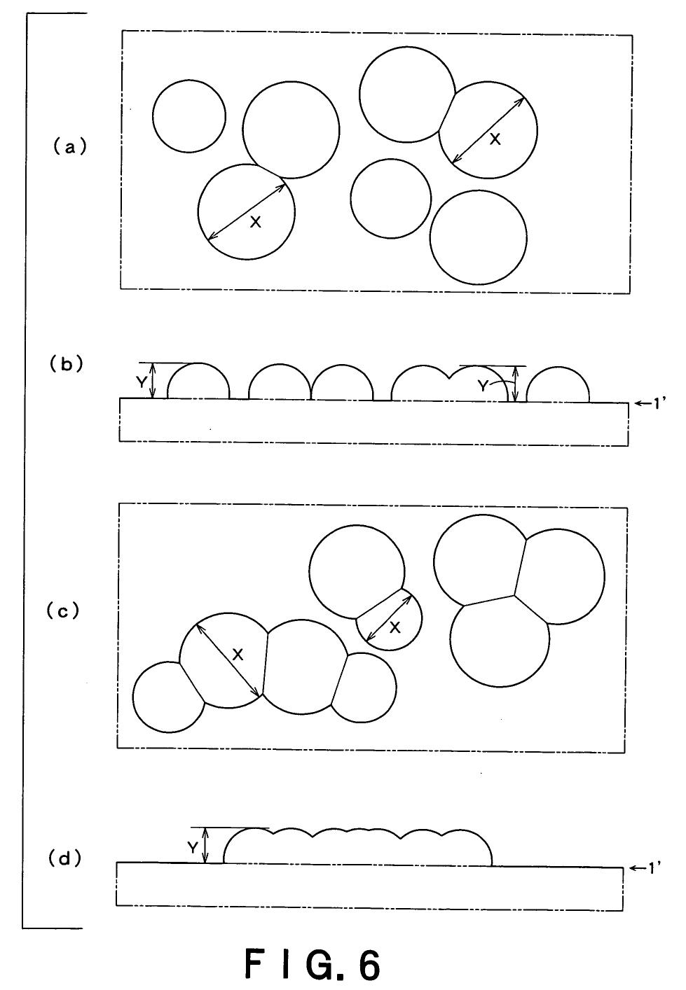

FIG. 5 is a schematic diagram of one specific embodiment of a preferred production process of a replication mold according to the present invention.

In the present invention, the above master is first provided. FIG. 5(a) shows a master according to the present invention.

Next, a resin negative mold (N1) which is in a reversed shape relationship with the convexes of the master shown in FIG. 5(b) is prepared using a master (P1) shown in FIG. 5(a). This resin negative mold (N1) may be produced, for example, by applying an uncured ultraviolet curable resin onto the master (P1) in its convex formed surface shown in FIG. 5(a), applying, in this state, ultraviolet light to the uncured ultraviolet curable resin to cure the resin, and separating the cured resin from the master (P1). For example, preferably, a method may be adopted in which an uncured ultraviolet curable resin is dropped on the master in its convex formed surface, a suitable resin film, for example, polyethylene terephthalate, is then applied by spreading the film over the whole surface of the ultraviolet curable resin, while bringing the resin film into intimate contact with the ultraviolet curable resin by a laminator such as a roller, ultraviolet light is then applied from the backside of the film to cure the ultraviolet curable resin, and the resin which has been cured together with the film is then separated from the surface of the master (P1). A concave face which is in a reversed shape relationship with the convexes of the master is formed on the peel face of the cured resin. A method which comprises applying an ultraviolet curable resin to a mold face with convexes or concaves in the master (P1), covering the applied ultraviolet curable resin with a film, applying ultraviolet light to the resin to cure the resin, and separating the cured resin together with the film from the mold surface to copy the shape of the mold surface will be referred to as a 2P method (a photopolymerization method) in the present specification.

When the master for antireflection structure formation is cylindrical or columnar and is durable, a resin negative mold (N1) can be prepared by a roll-to-roll process.

The negative mold (N1) shown in FIG. 5(b) as such can be utilized in the replication of an optical member. As described above, when the negative mold (N1) has been produced by an ultraviolet curable resin, the negative mold is sometimes unsuitable as a mold for replication on a mass production basis. Accordingly, in such a case, a method is preferably adopted in which a metallic negative mold (N2) having substantially the same surface structure as the resin negative mold (N1) is prepared and is used for replication of optical members using this metallic negative mold (N2).

This metallic negative mold (N2) may be produced by the steps as shown in FIG. 5(b) to FIG. 5(d).

An electrically conductive thin film is formed on the resin negative mold (N1) in its predetermined concave formed surface shown in FIG. 5(b), for example, by vapor deposition, and plating is then carried out on the thin film. Thereafter, a metallic positive mold (P2) with predetermined convexes formed on its surface shown in FIG. 5(c) is prepared by separating the negative mold (N1) from the plating part.

The electrically conductive thin film formed on the negative mold (N1) may be formed of, for example, nickel, chromium, gold or ITO. In the present invention, nickel is particularly preferred. The plating provided on this thin film is preferably a plating which has good adhesive strength to this thin film, for example, particularly preferably a nickel plating. Methods conducted before plating include those described in Japanese Patent Laid-Open No. 173791/2002, for example, the step of alkali degreasing in which the material is immersed in an alkali degreasing liquid for a short period of time and is then electrolyzed, the step of water washing, the step of acid activation in which the material is immersed in an acid, the step of drying, and the step of peeling film formation.

The positive mold (P2) shown in FIG. 5(c) is such that the fine convex structure formed on the surface of the master (P1) according to the present invention has been reproduced as a metal.

A plurality of positive molds (P2) having substantially identical concave information can be prepared by repeating the steps shown in FIG. 5(a) to FIG. 5(b) using the same negative mold (N1) a plurality of times. In this case, even when the metallic positive mold (P2) and the metallic negative mold (N2) are unsuitable for use as a result of damage or wear, the usable mold can easily be replaced.

In the present invention, a metallic negative mold (N2) for the replication of the antireflection structure shown in FIG. 5(d) is prepared from this metallic positive mold (P2), for example, by a metal plating method.

In preparing the metallic negative mold (N2) from the metallic positive mold (P2), if necessary, prior to plating, release treatment can be carried out on the surface of a positive mold (P2) from the viewpoint of facilitating the separation between the positive mold (P2) and the negative mold (N2). A preferred release treatment is to carry out the step of forming a peel film such as organic matter. Examples thereof include a method in which a fluoride material is vapor deposited and a method in which treatment with an organosulfur compound such as NIKKANONTACK (registered trademark, manufactured by Nihon Kagaku Sangyo Co., Ltd.) is carried out.

As with the metal plating in the preparation of a positive mold (P2), nickel plating is preferred as metal plating in the preparation of a metallic negative mold (N2).

This metallic negative mold (N2) may be used in replicating the antireflection structure and the optical member having this antireflection structure according to the present invention. Accordingly, the metal plating preferably has strength and durability high enough for the fine surface structure to be well reproduced in the replication. To this end, the metal plating is preferably formed in a thickness of at least about 0.1 to 3 mm.

In replicating the antireflection structure and the optical member having this antireflection structure according to the present invention, the optical member material can be shaped by this metallic negative mold (N2). The shaping can be carried out by a method in which a molten resin or softened resin is extruded or injected onto the surface of the metallic negative mold (N2) and the molten resin or softened resin may be shaped and cured under predetermined pressure and temperature conditions. Further, a method may also be adopted in which an ultraviolet curable resin is applied to this metallic negative mold (N2) and can be cured by exposure to ultraviolet light.

Thus, a number of the antireflection structure and the optical member having this antireflection structure according to the present invention can be replicated.

For example, when a master of a Fresnel lens shape shown in FIG. 5(b) is used as the master shown in FIG. 5(a), a large number of Fresnel lenses with the antireflection structure according to the present invention can be replicated.

Thus, the antireflection structure according to the present invention can easily be produced from a predetermined replication mold. Specifically, a number of optical members having an antireflection structure may be replicated by providing a replication mold capable of forming the predetermined antireflection structure and shaping the antireflection structure using this replication mold. Accordingly, the present invention can produce an optical member with a predetermined antireflection structure very stably in an easy and low-cost manner.

Further, according to the present invention, a predetermined antireflection structure can easily be formed even when the optical base material has a complicated surface shape.

All of P1, N1, P2, and N2 shown in FIGS. 5(a) to 5(d) are in a flat sheet form. However, it should be noted that P1, N1, P2, and N2 are not always required to be in a flat sheet form. For example, P1, N1, P2 and N2 may be in a curved surface form in which the surface is curved with a certain curvature. In particular, when N1 and N2 as a negative mold are curved with a certain curvature to constitute a cylindrical form and an antireflection structure of the negative mold is continuously provided on the outer peripheral face of the cylinder, a continuous antireflection structure formation can be formed on the surface of the base material by pressing the cylindrical N1 and N2 against the base material for antireflection structure formation while rotating the cylindrical N1, N2 to shape the base material surface. The method using the cylindrical N1 and N2 is particularly advantageous when the antireflection structure according to the present invention is continuously formed on a long base material. When a plurality of cylindrical N1 and N2 different from each other in antireflection structure are provided and are pressed on the whole surface or a part of one side or both sides of the base material for antireflection structure formation to shape the base material surface, a plurality of different antireflection structures according to the present invention can be formed on one side or both sides of a single base material.

B5. Optical Member

The optical member according to the present invention has the above antireflection structure.

The optical member according to the present invention has the above antireflection structure on its surface. The shape or form of the optical member with the antireflection structure formed thereon per se may be any one. Specifically, the optical member according to the present invention having the above antireflection structure may be any one, for example, those having a regular, irregular, geometric optical functional surface and/or shape, for example, those having, on the surface thereof, a linear, curved line, flat, curved face and/or convex-concave shape, particularly various shapes corresponding to the contemplated optical member, for example, Fresnel lenses, lenticular lenses, lens arrays, hologram sheets, prisms, light guide plates, light diffusing sheets, convex lens-like or concave lens-like shapes that can provide predetermined optical properties.

The optical member according to the present invention can be applied to various applications, for example, display devices and solar battery panels.

The optical member having the antireflection structure can effectively prevent light reflection. For example, in the case of optical members for information display such as display devices, the visibility is improved. On the other hand, in the case of light receiving optical members such as solar battery panels, efficiency for light utilization can be improved.

### EXAMPLES

### Example A1

(Preparation of Mold Having Fine Convexes on its Surface (Hereinafter Referred to as “Fine Convex Mold”))

A 0.4% aqueous polydiallyldimethylammonium salt (product name: PDDA, manufactured by Aldrich) solution containing 0.1 M concentration of sodium chloride and a 0.4% aqueous polystyrenesulfonate (product name: PSS, manufactured by Aldrich) solution containing 0.1 M concentration of sodium chloride were provided.

A cleaned glass substrate having a size of 5 cm square was immersed in a PDDA solution for 2 min and was thoroughly cleaned, and a PDDA adsorption layer was then formed on the surface of the thoroughly cleaned glass substrate. This substrate was immersed in a PSS solution for 2 min and was then thoroughly washed to form a composite film comprising a PDDA layer and a PSS layer stacked in that order on the surface of the glass substrate (“PDDA/PSS composite film”). This work was repeated 6 cycles, and, finally, a PDDA adsorption layer was provided, whereby a composite film in which the PDDA layer and the PSS layer are repeatedly stacked in that order 6 times and the PDDA layer is finally stacked was formed on the glass substrate (i.e., a composite film comprising six layers of (PDDA/PSS) and a layer of PDDA).

A polymer emulsion (product name: 0693, manufactured by JSR Corporation) of a carboxylated styrene/butadiene copolymer was diluted to a solid content of 24%. The composite film formed substrate was immersed in this emulsion for 2 min and was then thoroughly washed to form an adsorption layer of polymer fine particles on the substrate.

This substrate with the polymer fine particle adsorption layer formed thereon was immersed in the PDDA solution for 2 min and was then thoroughly washed to form a PDDA adsorption layer. This substrate was immersed in a PSS solution for 2 min and was then thoroughly washed to form a (PDDA/PSS) composite film. This cycle was repeated five times to form an overcoat layer comprising PDDA layers and PSS layers which had been repeatedly stacked in that order five times (five layers of (PDDA/PSS). Thus, a mold having on its surface fine convexes (fine convex mold) could be prepared.

(Evaluation of Fine Convex Mold)

The measurement of transmittance showed that the mold had antireflection properties and anti-dazzling properties. The surface of the mold was observed under a scanning electron microscope. As a result, it was confirmed that the convexes formed of fine particles were randomly distributed at a density of 1993/100 μm², the maximum value, minimum value, and average value of diameters of the basic forms of the convexes were 163 nm, 109 nm, and 138 nm, respectively, and at least 10% of basic forms of convexes were provided independently of each other. The maximum value, minimum value, and average value of the height of the basic forms of the convexes were 125 nm, 80 nm, and 97 nm, respectively. Likewise, the cross-section was observed. As a result, it was confirmed that the skirt part of the convexes was in a taper form. The average height of the basic forms of the convexes was 101 nm.

(Preparation of Master)

A resin master was prepared by a 2P method (a photopolymerization method) using a composition composed mainly of an acrylic photopolymerizable material with the fine convex mold.

(Evaluation of Master)

The measurement of the transmittance showed that, for this master, a 1.2% improvement in transmittance was achieved over the untreated resin plate. Further, as a result of observation under an electron microscope, it was found that this master had concaves having a reversed shape relationship with the convexes in the fine convex mold.

(Preparation of Metallic Replication Mold)

A nickel thin layer was formed by nickel vapor deposition on the resin master. This method was used for nickel plating to prepare a replication mold.

### Example A2

(Preparation of Fine Convex Mold)

A fine convex mold was prepared in the same manner as in Example A1, except that the solid content of the polymer emulsion was regulated to 16%.

(Evaluation of Fine Convex Mold)

The measurement of transmittance showed that the fine convex mold had antireflection properties. The mold was observed under a scanning electron microscope. As a result, it was confirmed that the convexes formed of fine particles were randomly distributed at a density of 1689/100 μm², the maximum value, minimum value, and average value of diameters of the convexes were 163 nm, 82 nm, and 140 nm, respectively, and at least 10% of the convexes were provided independently of each other. The maximum value, minimum value, and average value of the height of the convexes were 118 nm, 67 nm, and 99 nm, respectively. Likewise, the cross-section was observed. As a result, it was confirmed that the skirt part of the convexes was in a taper form. The average height of the basic forms of the convexes was 105 nm.

(Preparation of Master)

A resin master was prepared by a 2P method (a photopolymerization method) using a composition composed mainly of an acrylic photopolymerizable material with the fine convex mold.

(Evaluation of Master)

The measurement of the transmittance showed that, for the resin negative mold, a 1.6% improvement in transmittance was achieved over the untreated resin plate. Further, as a result of observation under an electron microscope, it was found that this master had concaves which reflected the fine convex mold.

(Preparation of Metallic Replication Mold)

A nickel-thin layer was formed by nickel vapor deposition on the resin master. This was used for nickel plating to prepare a metallic replication mold.

### Example A3

(Preparation of Fine Convex Mold)

A fine convex mold having an antireflection structure was prepared in the same manner as in Example A1, except that a silica fine particle dispersion liquid (tradename: SPHERICA-SLURRY 120, manufactured by Catalysts and Chemicals Industries Co., Ltd.) having a solid content regulated to 18% was used instead of JSR 0693 having a solid content regulated to 24%.

(Evaluation of Fine Convex Mold)

The measurement of transmittance showed that the fine convex mold had antireflection properties. The mold was observed under a scanning electron microscope. As a result, it was confirmed that the basic forms of the convexes formed of fine particles were randomly distributed at a density of 1822/100 μm², the maximum value, minimum value, and average value of diameters of the convexes were 143 nm, 80 nm, and 130 nm, respectively, and at least 10% of the basic forms of the convexes were provided independently of each other. The maximum value, minimum value, and average value of the height of the convexes were 120 nm, 71 nm, and 108 nm, respectively. Likewise, the cross-section was observed. As a result, it was confirmed that the skirt part of the basic forms of the convexes was in a taper form. The average height of the basic forms of the convexes was 118 nm.

(Preparation of Master)

A resin master was prepared by a 2P method (a photopolymerization method) using a composition composed mainly of an acrylic photopolymerizable material with the fine convex mold.

(Evaluation of Master)

The measurement of the transmittance showed that, for the resin master, a 1.4% improvement in transmittance was achieved over the untreated resin plate. Further, as a result of observation under an electron microscope, it was found that this resin master had concaves which reflected the fine convex mold.

(Preparation of Metallic Replication Mold)

A nickel thin layer was formed by nickel vapor deposition on the resin master. This was used for nickel plating to prepare a metallic replication mold.

### Example A4

(Preparation of Fine Convex Mold)

In the same manner as in Example A1, a composite film composed of six layers of (PDDA/PSS) and one layer of PDDA was formed on a Fresnel lens sheet having a size of 10 cm square. A polymer fine particle layer was formed in the same manner as in Example A1, except that a polymer emulsion having a solid content of 16% as used in Example A2 was used. This substrate was treated at 50° C. for 2 min. Thereafter, in the same manner as in Example A1, an overcoat layer [that is, five layers of (PDDA/PSS)] was formed to form a fine convex mold.

(Evaluation of Fine Convex Mold)

Observation under a scanning electron microscope showed that the surface of the treated Fresnel lens sheet had an antireflection structure having a convex distributed state as in Example A2.

(Preparation of Master)

A resin master was prepared by a 2P method (a photopolymerization method) using a composition composed mainly of an acrylic photopolymerizable material with the fine convex mold.

(Evaluation of Master)

As a result of observation under an electron microscope, it was found that, as in Example A2, this resin master had concaves which reflected the fine convex mold.

(Preparation of Metallic Replication Mold)

A nickel thin layer was formed by nickel vapor deposition on the resin master. This was used for nickel plating to prepare a metallic replication mold having an antireflection structure.

### Example A5

(Preparation of Fine Convex Mold)

A Fresnel lens mold for a 50-in rear projection television was washed with a commercially available detergent, and, in the same manner as in Example A1, a composite film composed of six layers of (PDDA/PSS) and one layer of PDDA was formed on the surface of the mold.

A silica fine particle dispersion liquid (MP-1040, manufactured by Nissan Chemical Industries Ltd.) was diluted to 10%, and a silica fine particle adsorption layer was formed on the film formed mold surface using this diluted dispersion liquid in the same manner as in Example A1.

An overcoat layer [that is, five layers of (PDDANPSS)] was formed on the surface of the silica fine particle layer formed mold in the same manner as in Example A1.

Thus, a Fresnel lens mold having fine convexes was prepared.

(Replication of Lens Sheet)

A Fresnel lens sheet having fine concaves was replicated by a 2P method (photopolymerization method) using a Fresnel lens mold having the fine convexes. As a result, at least 50 sheets could be continuously replicated.

(Evaluation of Replicated Lens Sheets)

As a result of the measurement of transmittance, it was found that the reflectance was reduced by about 1.6% as compared with the fine concave-free Fresnel lens sheet. As a result of observation under a scanning electron microscope, it was found that the concaves formed of fine particles were randomly distributed at a density of 3866/100 μm², the maximum value, minimum value, and average value of diameters of the basic forms of the concaves were 141 nm, 100 nm, and 121 nm, respectively, and at least 10% of basic forms of the concaves were provided independently of each other by convex boundaries. The maximum value, minimum value, and average value of the depth of the basic forms of the concaves were 120 nm, 64 nm, and 91 nm, respectively.

### Example A6

(Preparation of Fine Convex Mold)

A solution of a fluoro silane coupling agent (XC98-B2472, manufactured by GE Toshiba Silicones) diluted with isopropyl alcohol by a factor of ten was spin coated onto a fine convex mold prepared in the same manner as in Example A3, and the coating was heat treated at 150° C. for 15 min. The assembly was visually inspected. As a result, it was confirmed that the assembly had antireflection properties. Further, the value of water contact as measured using 1 μl of water droplets was 131 degrees. These facts demonstrate that the assembly had a fluoro silane coupling agent coating.

(Preparation of Replication Product with Fine Concaves)

Resin replication products with fine concaves were prepared by 2P (photopolymerization method) using the above fine convex mold. The replication could be carried out at least 100 times. As a result of the measurement of transmittance, it was found that a 1.3% improvement on average in transmittance could be realized.

### Example B1

(Preparation of Master Having Antireflection Structure)

A 0.4% aqueous polydiallyldimethylammonium salt (tradename: PDDA, manufactured by Aldrich) solution containing 0.1 M concentration of sodium chloride and a 0.4% aqueous polystyrenesulfonate (tradename: PSS, manufactured by Aldrich) solution containing 0.1 M concentration of sodium chloride were provided.

A cleaned glass substrate having a size of 5 cm square was immersed in a PDDA solution for 2 min and was thoroughly cleaned, and a PDDA adsorption layer was then formed on the surface of the thoroughly cleaned glass substrate. This substrate was immersed in a PSS solution for 2 min and was then thoroughly washed to form a composite film comprising a PDDA layer and a PSS layer stacked in that order on the surface of the glass substrate (“(PDDA/PSS) composite film”). This work was repeated 6 cycles, and, finally, a PDDA adsorption layer was provided, whereby a composite film in which the PDDA layer and the PSS layer are repeatedly stacked in that order 6 times and the PDDA layer is finally stacked was formed on the glass substrate (i.e., a composite film comprising six layers of (PDDA/PSS) and a layer of PDDA).

A polymer emulsion (product name: 0693, manufactured by JSR Corporation) of a carboxylated styrene/butadiene copolymer was diluted to a solid content of 24%. The composite film formed substrate was immersed in this emulsion for 2 min and was then thoroughly washed to form an adsorption layer of polymer fine particles on the substrate.

This substrate with the polymer fine particle adsorption layer formed thereon was immersed in the PDDA solution for 2 min and was then thoroughly washed to form a PDDA adsorption layer. This substrate was immersed in a PSS solution for 2 min and was then thoroughly washed to form a (PDDA/PSS) composite film. This cycle was repeated five times to form an overcoat layer comprising PDDA layers and PSS layers which had been repeatedly stacked in that order five times (five layers of (PDDA/PSS)). Thus, a master could be prepared.

(Evaluation of Master with Antireflection Structure)

The measurement of transmittance showed that the mold had antireflection properties and anti-dazzling properties. The surface of the mold was observed under a scanning electron microscope. As a result, it was confirmed that basic forms of the convexes formed of fine particles were randomly distributed at a density of 1933/100 μm², the maximum value, minimum value, and average value of diameters of the basic forms of the convexes were 163 nm, 109 nm, and 138 nm, respectively, and at least 10% of basic forms of convexes were provided independently of each other. Likewise, the cross-section was observed. As a result, it was confirmed that the reversed taper shape of the skirt part in the basic forms of the convexes was eliminated. Further, the average height of the basic forms of the convexes was 101 nm.

(Preparation of Resin Negative Mold)

A resin negative mold was prepared by a 2P method (a photopolymerization method) using a composition composed mainly of an acrylic photopolymerizable material with the master.

(Evaluation of Resin Negative Mold)

The measurement of the transmittance showed that, for this resin negative mold, a 1.2% improvement in transmittance was achieved over the untreated resin plate. Further, as a result of observation under an electron microscope, it was found that this resin negative mold had concaves which reflected the master.

(Preparation of Metallic Positive Mold)

A nickel thin layer was formed by nickel vapor deposition on the resin negative mold. This was used for nickel plating to prepare a metallic positive mold.

(Preparation of Metallic Negative Mold)

A peel film was formed using an organosulfur compound (NIKKANONTACK (registered trademark), manufactured by Nihon Kagaku Sangyo Co., Ltd.) on the metallic positive mold, followed by nickel plating. The plating layer was then separated to prepare a metallic negative mold from the metallic positive mold.

### Example B2

(Preparation of Master Having Antireflection Structure)

A master having an antireflection structure was prepared in the same manner as in Example B1, except that the solid content of the polymer emulsion was regulated to 16%.

(Evaluation of Master Having Antireflection Structure)

The measurement of transmittance showed that the master had antireflection properties. As a result of observation under a scanning electron microscope, it was confirmed that the basic forms of the convexes formed of fine particles were distributed randomly at a density of 1689/100 μm², the maximum value, minimum value, and average value of diameters of the basic forms of the convexes were 163 nm, 82 nm, and 140 nm, respectively, and at least 10% of basic forms of convexes were provided independently of each other. Likewise, the cross-section was observed. As a result, it was confirmed that the reversed taper shape of the skirt part in the basic forms of the convexes was eliminated. Further, the average height of the basic forms of the convexes was 105 nm.

(Preparation of Resin Negative Mold)

A resin negative mold was prepared by a 2P method (a photopolymerization method) using a composition composed mainly of an acrylic photopolymerizable material with the master.

(Evaluation of Resin Negative Mold)

The measurement of the transmittance showed that, for this resin negative mold, a 1.6% improvement in transmittance was achieved over the untreated resin plate. Further, as a result of observation under an electron microscope, it was found that this resin negative mold had concaves which reflected the master.

(Preparation of Metallic Positive Mold)

A nickel thin layer was formed by nickel vapor deposition on the resin negative mold. This was used for nickel plating to prepare a metallic positive mold.

(Preparation of Metallic Negative Mold)

A peel film was formed using an organosulfur compound (NIKKANONTACK (registered trademark), manufactured by Nihon Kagaku Sangyo Co., Ltd.) on the metallic positive mold, followed by nickel plating. The plating layer was then separated to prepare a metallic negative mold from the metallic positive mold.

### Example B3

(Preparation of Master with Antireflection Structure)

A master having an antireflection structure was prepared in the same manner as in Example B1, except that a silica fine particle dispersion liquid (tradename: SPHERICA-SLURRY 120, manufactured by Catalysts and Chemicals Industries Co., Ltd.) having a solid content regulated to 18% was used.

(Evaluation of Master with Antireflection Structure)

The measurement of transmittance showed that the master had antireflection properties. As a result of observation under a scanning electron microscope, it was confirmed that the basic forms of the convexes formed of fine particles were distributed randomly at a density of 1822/100 μm², the maximum value, minimum value, and average value of diameters of the convexes were 143 nm, 80 nm, and 130 nm, respectively, and at least 10% of basic forms of convexes were provided independently of each other. Likewise, the cross-section was observed. As a result, it was confirmed that the reversed taper shape of the skirt part in the basic forms of the convexes was eliminated. Further, the average height of the basic forms of the convexes was 118 nm.

(Preparation of Resin Negative Mold)

A resin negative mold was prepared by a 2P method (a photopolymerization method) using a composition composed mainly of an acrylic photopolymerizable material with the master.

(Evaluation of Resin Negative Mold)

The measurement of the transmittance showed that, for this resin negative mold, a 1.4% improvement in transmittance was achieved over the untreated resin plate. Further, as a result of observation under an electron microscope, it was found that this resin negative mold had concaves which reflected the master.

(Preparation of Metallic Positive Mold)

A nickel thin layer was formed by nickel vapor deposition on the resin negative mold. This was used for nickel electrocasting to prepare a metallic positive mold.

(Preparation of Metallic Negative Mold)

A peel film was formed using an organosulfur compound (NIKKANONTACK (registered trademark), manufactured by Nihon Kagaku Sangyo Co., Ltd.) on the metallic positive mold, followed by nickel plating. The plating layer was then separated to prepare a metallic negative mold from the metallic positive mold.

### Example B4

(Preparation of Master with Antirefleciton Structure)

In the same manner as in Example B1, a composite film composed of six layers of (PDDANPSS) and one layer of PDDA was formed on a Fresnel lens sheet having a size of 10 cm square. A polymer fine particle layer was formed in the same manner as in Example B1, except that a polymer emulsion having a solid content of 16% as used in Example B2 was used. This substrate was treated at 50° C. for 2 min. Thereafter, in the same manner as in Example B1, an overcoat layer [that is, five layers of (PDDA/PSS)] was formed to provide a master comprising an antireflection structure provided on the lens concave-convex face of the Fresnel lens sheet.

(Evaluation of Master with Antireflection Structure)

Observation under a scanning electron microscope showed that the surface of the Fresnel lens sheet as the master had an antireflection structure which was in a convex distributed state as in Example B2.

(Preparation of Resin Negative Mold)

A resin negative mold was prepared by a 2P method (a photopolymerization method) using a composition composed mainly of an acrylic photopolymerizable material with the master.

(Evaluation of Resin Negative Mold)

As a result of observation under an electron microscope, it was found that this resin negative mold had concaves which reflected the master as in Example B2.

(Preparation of Metallic Positive Mold)

A nickel thin layer was formed by nickel vapor deposition on the resin negative mold. This was used for nickel electrocasting to prepare a metallic positive mold with an antireflection structure.

(Preparation of Metallic Negative Mold)

A peel film was formed using an organosulfur compound (NIKKANONTACK (registered trademark), manufactured by Nihon Kagaku Sangyo Co., Ltd.) on the metallic positive mold, followed by nickel plating. The plating layer was then separated to prepare a metallic negative mold from the metallic positive mold.

### Example B5

(Preparation of Master with Antireflection Structure)

A Fresnel lens mold for a 50-in rear projection television was washed with a commercially available detergent, and, in the same manner as in Example B1, a composite film composed of six layers of (PDDA/PSS) and one layer of PDDA was formed on the surface of the mold.

A silica fine particle dispersion liquid (MP-1040, manufactured by Nissan Chemical Industries Ltd.) was diluted to 10%, and a silica fine particle adsorption layer was formed on the film formed mold surface using this diluted dispersion liquid in the same manner as in Example B1.

An overcoat layer [that is, five layers of (PDDA/PSS)] was formed on the surface of the silica fine particle layer formed mold in the same manner as in Example B1.

Thus, a Fresnel lens mold having fine convexes was prepared.

(Replication of Lens Sheet with Antireflection Structure)

A Fresnel lens sheet having fine concaves was replicated by a 2P method (photopolymerization method) using the Fresnel lens mold having fine convexes (a resin negative mold). As a result, at least 50 sheets could be continuously replicated.

(Evaluation of Replicated Resin Negative Mold)

As a result of the measurement of transmittance, it was found that the reflectance was reduced by about 1.6% as compared with the fine concave-free Fresnel lens sheet. As a result of observation under a scanning electron microscope, it was found that the concaves formed of fine particles were randomly distributed at a density of 3866/100 μm², the maximum value, minimum value, and average value of diameters of the basic forms of the concaves were 141 nm, 100 nm, and 121 nm, respectively, and at least 10% of basic forms of the concaves were provided independently of each other by convex boundaries. The maximum value, minimum value, and average value of the depth of the basic forms of the concaves were 120 nm, 64 nm, and 91 nm, respectively.

(Preparation of Metallic Positive Mold)

A nickel thin layer was formed by nickel electroless plating on the resin negative mold. This was used for nickel electrocasting to prepare a metallic positive mold with an antireflection structure.

(Preparation of Metallic Negative Mold)

A peel film was formed using an organosulfur compound (NIKKANONTACK (registered trademark), manufactured by Nihon Kagaku Sangyo Co., Ltd.) on the metallic positive mold, followed by nickel plating. The plating layer was then separated to prepare a metallic negative mold from the metallic positive mold.

### Example B6

(Preparation of Master with Antireflection Structure)

A solution of a fluoro silane coupling agent (XC98-B2472, manufactured by GE Toshiba Silicones) diluted with isopropyl alcohol by a factor of ten was spin coated onto the overcoated fine convex mold prepared in the same manner as in Example B3, and the coating was heat treated at 150° C. for 15 min. The assembly was visually inspected. As a result, it was confirmed that the assembly had antireflection properties. Further, the value of water contact as measured using 1 μl of water droplets was 131 degrees. These facts demonstrate that the assembly had a fluoro silane coupling agent coating.

(Preparation of Replication Product with Antireflection Structure)

Resin replication products with fine concaves (resin negative mold) were prepared by 2P (photopolymerization method) using the above fine convex mold. The replication could be carried out at least 100 times. As a result of the measurement of transmittance, it was found that a 1.3% improvement on average in transmittance could be realized.

(Preparation of Metallic Positive Mold)

A nickel thin layer was formed by nickel vapor deposition on the resin negative mold. This was used for nickel electrocasting to prepare a metallic positive mold with an antireflection structure.

(Preparation of Metallic Negative Mold)

A peel film was formed using an organosulfur compound (NIKKANONTACK (registered trademark), manufactured by Nihon Kagaku Sangyo Co., Ltd.) on the metallic positive mold, followed by nickel plating. The plating layer was then separated to prepare a metallic negative mold from the metallic positive mold.

1. An antireflection structure having on its surface an antireflection face with fine concaves, wherein
10 to 90% of the effective area of the antireflection face is accounted for by said concaves, and
said concaves comprise basic forms which may be connected to each other, said basic forms have an average depth of 30 nm to 200 nm and an average diameter of 80 nm to 400 nm, and said basic forms are substantially irregularly arranged on said antireflection face.

2. The antireflection structure according to claim 1, wherein the frequency distribution of the diameter of said concaves is narrow.

3. The antireflection structure according to claim 2, wherein the frequency distribution of the diameter of said concaves is narrow and such that the number of concaves which are different in diameter by not more than 75 nm from concaves of the highest frequency is not less than 70% of the number of concaves which are different in diameter by not more than 300 nm from concaves of the highest frequency.

4. The antireflection structure according to claim 1, wherein the proportion of said concaves not connected to each other to the total number of said concaves is not less than 10%.

5. An optical member comprising an antireflection structure according to claim 1.

6. The optical member according to claim 5, wherein the antireflection structure is provided on a surface of a geometrical optical functional shape.

7. A display device comprising an antireflection structure according to claim 1.

8. The display device according to claim 7, wherein the antireflection structure is provided on a surface of a geometrical optical functional shape.

9. A solar battery panel comprising an antireflection structure according to claim 1.

10. The solar battery panel according to claim 9, wherein the antireflection structure is provided on a surface of a geometrical optical functional shape.

11. A master for the formation of an antireflection structure having on its surface an antireflection face with fine concaves, wherein
said master comprises:
a base material; and
fine concaves provided on said base material, and wherein
10 to 90% of the effective area of the antireflection face is accounted for by said concaves, and
said concaves comprise basic forms which may be connected to each other, said basic forms have an average depth of 30 nm to 200 nm and an average diameter of 80 nm to 400 nm, and said basic forms are substantially irregularly arranged on said antireflection face.

12. A process for producing a master for the formation of an antireflection structure, said process comprising the steps of:
producing a master according to claim 11,
forming a substrate layer on the surface of a base material optionally by an alternate adsorption method; and
then fixing fine particles on said substrate layer to form fine convexes.

13. The process for producing a master according to claim 12, wherein the formation of said substrate layer by the alternate adsorption method is carried out by using a combination of the step of immersing said base material in an aqueous positive electrolyte polymer solution with the step of immersing said base material in an aqueous negative electrolyte polymer solution.

14. The process for producing a master according to claim 13, which comprises the step of depositing fine particles by applying a fine particle dispersion liquid onto said substrate layer.

15. The process for producing a master according to claim 12, wherein, after the deposition of the fine particles, the fine particle-deposited surface is subjected to heat treatment and/or overcoating.

16. The process for producing a master according to claim 12, wherein the skirt part in the convexes formed of the fine particles is not substantially in a reverse taper form.

17. A process for producing a replication mold from a master, said process comprising:
providing a master according to claim 11; and
preparing a metallic negative mold for replicating an antireflection structure from said master by a metal plating method.

18. An antireflection structure having on its surface an antireflection face having fine convexes, wherein
10 to 90% of the effective area of the antireflection face is accounted for by said convexes, and
said convexes comprise basic forms which may be connected to each other, said basic forms have an average height of 30 nm to 200 nm and an average diameter of 80 nm to 400 nm, and said basic forms are substantially irregularly arranged on said antireflection face.

19. The antireflection structure according to claim 18, wherein the frequency distribution of the diameter of said convexes is narrow.

20. The antireflection structure according to claim 19, wherein the frequency distribution of the diameter of said convexes is narrow and such that the number of convexes which are different in diameter by not more than 75 mn from convexes of the highest frequency is not less than 70% of the number of convexes which are different in diameter by not more than 300 nm from convexes of the highest frequency.

21. The antireflection structure according to claim 18, wherein the proportion of said convexes not connected to each other to the total number of said convexes is not less than 10%.

22. An optical member comprising an antireflection structure according to claim 18.

23. The optical member according to claim 22, wherein the antireflection structure is provided on a surface of a geometrical optical functional shape.

24. A display device comprising an antireflection structure according to claim 18.

25. The display device according to claim 24, wherein the antireflection structure is provided on a surface of a geometrical optical functional shape.

26. A solar battery panel comprising an antireflection structure according to claim 18.

27. The solar battery panel according to claim 26, wherein the antireflection structure is provided on a surface of a geometrical optical functional shape.

28. A master for the formation of an antireflection structure having on its surface an antireflection face with fine convexes, wherein
said master comprises:
a base material; and
fine convexes provided on said base material, and where
10 to 90% of the effective area of the antireflection face is accounted for by said convexes, and
said convexes comprise basic forms which may be connected to each other, said basic forms have an average height of 30 nm to 200 nm and an average diameter of 80 nm to 400 nm, and said basic forms are substantially irregularly arranged on said antireflection face.

29. A process for producing a master for the formation of an antireflection structure, said process comprising the steps of:
producing a master according to claim 28,
forming a substrate layer on the surface of a base material optionally by an alternate adsorption method; and
then fixing fine particles on said substrate layer to form fine convexes.

30. The process for producing a master according to claim 29, wherein the formation of said substrate layer by the alternate adsorption method is carried out by using a combination of the step of immersing said base material in an aqueous positive electrolyte polymer solution with the step of immersing said base material in an aqueous negative electrolyte polymer solution.

31. The process for producing a master according to claim 30, which comprises the step of depositing fine particles by applying a fine particle dispersion liquid onto said substrate layer.

32. The process for producing a master according to claim 29, wherein, after the deposition of the fine particles, the fine particle-deposited surface is subjected to heat treatment and/or overcoating.

33. The process for producing a master according to claim 29, wherein the skirt part in the convexes formed of the fine particles is not substantially in a reverse taper form.

34. A process for producing a replication mold from a master, said process comprising:
providing a master according to claim 28;
preparing a resin negative mold which has been formed, in a reversed shape relationship with the convexes of the master, using said master;
preparing a metallic positive mold from said resin negative mold by metal plating; and
preparing, by metal plating, a metallic negative mold as a replication mold for replicating an antireflection structure from said metallic positive mold prepared in the step just above.
